(19) United States
(12) Patent Application Publication
(10) Pub. No.: US 2018/0306411 A1
(43) Pub. Date: Oct. 25, 2018

(54) PROJECTION LIGHT WITH COLOR FILM

(71) Applicant: Jun Xi, Dongguan (CN)

(72) Inventor: Jun Xi, Dongguan (CN)

(21) Appl. No.: 15/599,676

(22) Filed: May 19, 2017

(30) Foreign Application Priority Data
Apr. 20, 2017 (CN) 201720416604.3

(51) Int. Cl. F21V 14/00; F21V 21/30

(52) U.S. Cl. CPC F21V 14/006; F21V 21/14; F21V 21/30

(57) ABSTRACT

The present invention provides a projection light with color film including a light source, a color film which can resist a temperature higher than 80 degrees Celsius without deformation and color fading, a film support configured for retaining the color film, a light guide column configured between the film support and the light source and configured for transmitting light from the light source to the color film, and a lens configured at a side of the color film and for receiving light passing through the color film. By using the PET material, the film base of the color film 40 has the ability to resist a high temperature up to 120 degrees Celsius. By using anti-uv screening inks, the printing layers do not easy to color fade. Therefore, the color film can operate properly without deformation and color fading during its lifetime.

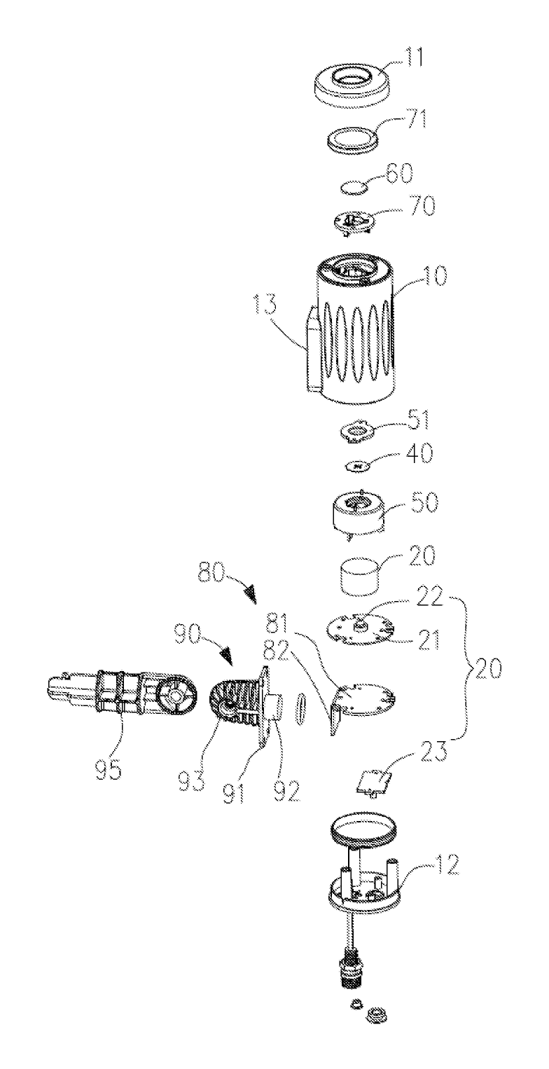

### BACKGROUND OF THE INVENTION

### 1. Field of the Invention

The present invention relates to outdoor illumination devices, and more particularly to a projection light with color film.

### 2. Description of Related Art

One type of traditional projection lights use a lens, a black and white or color film (transparency, can be used in overhead projectors) formed by chemical exposure and one or more LED light source. However, the LED light source will produces lots of heat and a temperature in the projection light can be up to 50 degrees Celsius, or even higher than 80 degrees Celsius. Furthermore, there are lots of uv (ultraviolet) rays in the light rays of the LED light source. These will damage the film (cause deformation) and result in color fading.

Another type of traditional projection lights use a printed glass to replace the film. The disadvantages of the printed glass include its fragility, hard to assemble and nonuniform coloring. Furthermore, the printing ink on the glass easy to fall off at high temperature.

The other method is to use the printed glass as a projection film, the drawback is fragile, easy to assemble and print uniform coloring is extremely difficult, easy to heat the glass material led to high temperature drop off the ink, The impact of the normal use of the projection light.

Therefore, there is a need for a projection light with color film with high temperature resistance and anti-uv.

### BRIEF DESCRIPTION OF THE SEVERAL VIEWS OF THE DRAWING(S)

The foregoing and other exemplary purposes, aspects and advantages of the present invention will be better understood in principle from the following detailed description of one or more exemplary embodiments of the invention with reference to the drawing, in which:

The FIGURE is an exploded view of a projection light.

### DETAILED DESCRIPTION OF THE INVENTION

The invention will now be described in detail through several embodiments with reference to the accompanying drawing.

Please refer to the drawing, a projection light with color film in accordance with an embodiment of the present invention maily includes a body case 10 housing a light source 20, a light guide column 30, a color film 40, a film support 50, a lens 60, a lens holder 70, and a heat radiator 80 attached to the light source 20.

The body case 10 is substantially cylindrical tubular with two ends opening, one end (front opening) is covered by a front cover 11 and is used for outputting light, the other end (rear opening) is covered by a rear cover 12 and is used for electrical connection and maintenance. The body case 10 further defines a middle opening 13 in its side wall close to the rear opening in the embodiment. For the convenience of the description, a side/surface/direction towards the front opening is defined a front side/surface/direction, and a side/surface/direction towards the rear opening is defined the rear side/surface/direction.

The light source 20 mainly includes a first circuit board 21 with a surface attached to the heat radiator 80, one LED light 22 fixed on the other surface of the first circuit board 21, and a second circuit board 23 electrically connected with the first circuit board 21 and fixed to the the rear cover 12 of the body case 10. The second circuit board 23 is spaced apart with the heat radiator 80, and is a control circuit of the LED light 22. The first circuit board 23 is mainly used for supplying current to the LED light.

In the embodiment, the heat radiator 80 is an L-shaped metal piece, includes a substantially circular first metal plate 81 and a second metal plate 82 substantially perpendicular with the first metal plate 81. The first metal plate 82 is fixed in the body case 10 and is set substantially perpendicular to the side wall of the body case 10, and the second metal plate 82 is facing the middle opening 13 of the body case 10. The first circuit board 21 is attached to a surface (front surface) of the first metal plate 82 from a front side.

The projection light further includes a heat transmission part 90 and a supporting arm 95. The heat transmission part 90 is made from metal and includes a plate 91 connected to the side wall of the body case 10 from outside, a solid post 92 extending substantially perpendicularly from a surface of the plate 91 and is inserted into the middle opening 13 to abut against the second metal plate 82, and a mounting block 93 extending substantially perpendicularly from another surface of the plate 91 and is used for rotatably connected with the supporting arm 95. Heat generated by the LED light 22 and the first circuit board 21 is transmitted to the heat transmission part 90 and the supporting arm 95 via the heat radiator 80. Therefor a temperature within the body case cannot be up to 80 degrees Celsius. Preferably, the temperature within the body case cannot be up to 50 degrees Celsius. Particularly, a layer of heat-conducting adhesive (not shown) is set between the heat radiator 80 and the heat transmission part 90.

The light guide column 30 is fixed in the body case 10 and is at a front side of the LED light 22, and is used for receiving light from the light source 20 and transmitting the light to the color film 40. In the embodiment, the light guide column 30 is a cylindrical solid column made from polymethyl methacrylate (Acrylic, also known as PMMA), a end of the column 30 faces to the LED light 22, and the other end of the column 30 faces to the color film 40.

The film support 50 is fixed in the body case 10 and is at a front side of the light guide column 30. The film support 50 defines a through hole passing through its two ends, a rear end of the film support 50 faces the light guide column 30, and the front end of the film support 50 faces to the lens 60. The color film 40 is circular and is received in the through hole at the front end of the film support 50, and a cover 51 with a circular opening in the center is fixed to the front end of the film support 50. The circular opening of the cover 51 is smaller than the color film 40, thus can secure the color film 40 to the film support 50, and light passing through the color film 40 can emit out via the circular opening of the cover 51.

The color film 40 should resist a temperature higher than 80 degrees Celsius without deformation and color fading. In the embodiment, the color film 40 includes a film base made from polyethylene terephthalate (PET), and several printing layers prined on a front surface of the film base in sequence. Each printing layer is formed by screen printing utilizing a color anti-uv (ultraviolet light) screening ink. Furthermore, a thickness of the film base is 0.8˜1.5 mm, a total thickness of the several printing layers is 0.05˜0.1 mm. Therefore, the color film 40 can resist a temperature higher than 80 degrees Celsius without deformation and color fading.

The lens 60 is a convex lens, it is held by the lens holder 70. The lens holder 70 defines a through hole in its center for receiving the lens 60, and it is fixed in the body case 10 near a front end of the body case 10. An annular cover 71 is covered on the lens holder 70 to prevent the lens 60 from falling off the lens holder 70. It is understandably, the front cover 11 defines a hole sealed with a glass or other transparent material to let light from the lens 60 pass through.

In operation, when the LED light 22 is powered on, the LED light 22 starts to emit light, the light rays pass through the light guide column 30, then reaches the color film 40. The light rays changes according to the colors and the transmittance of light of the several printing layers of the color film 40 when passing through the color film 40. The light rays finally pass through the lens 60 and emit out of the body case 10.

To sum up, by using the PET material, the film base of the color film 40 has the ability to resist a high temperature up to 120 degrees Celsius, thus not easy to deformation. By using color anti-uv screening inks, the printing layers can resist ultraviolet light in the light rays, thus not easy to fade. Because of the heat radiator 80 and the heat transmission part 90, the heat generated by the LED light 22 and the first circuit board 21 can be transmitted out of the body case 10 quickly, therefore the temperature in the body case 10 cannot raise to 80 or 50 (may be any value within 50˜80) degrees Celsius. Furthermore, a protect circuit on the second circuit board 23 will cut off the power supply to the LED light 22 when the temperature in the body case 10 is higher than 80 or 50 (may be any value within 50˜80) degrees Celsius because of failure or abnormal conditions. Therefore, the color film can operate properly without deformation and color fade during its lifetime.

While the invention has been described in terms of several exemplary embodiments, those skilled on the art will recognize that the invention can be practiced with modification within the spirit and scope of the appended claims. In addition, it is noted that, the Applicant's intent is to encompass equivalents of all claim elements, even if amended later during prosecution.

What is claimed is:

1. A projection light with color film, comprising:
a light source;
a color film which can resist a temperature higher than 80 degrees Celsius without deformation and color fading;
a film support configured for retaining the color film;
a light guide column configured between the film support and the light source and configured for transmitting light from the light source to the color film; and
a lens configured at a side of the color film and for receiving light passing through the color film.

2. The projection light of claim 1, wherein the color film comprises:
a film base made from polyethylene terephthalate; and
a plurality of printing layers prined on a surface of the film base in sequence;
wherein each printing layer is formed by screen printing utilizing an anti-uv screening ink.

3. The projection light of claim 2, wherein the light guide column is a cylindrical solid column made from polymethyl methacrylate.

4. The projection light of claim 2, wherein a thickness of the film base is 0.8˜1.5 mm, a total thickness of the plurality of printing layers is 0.05˜0.1 mm.

5. The projection light of claim 3, further comprising:
a heat radiator attached to the light source;
a body case with a front cover covering a front opening, a rear cover covering a rear opening and defining a middle opening, the body case configured for receiving the light source, the color film, the film support, the light guide column, the lens and the heat radiator; and
a heat transmission part with a first end inserting in the body case through the middle opening and attached to the heat radiator, and a second end of the heat transmission part being out of the body case.

6. The projection light of claim 5, wherein the heat radiator comprises a first metal plate; the light source comprises:
a first circuit board with a surface attached to a surface of the first metal plate;
one or more LED light fixed on the other surface of the first circuit board; and
a second circuit board electrically connected with the first circuit board and fixed to a rear end of the body case and spaced apart with the other surface of the first metal plate.

7. The projection light of claim 6, wherein the heat radiator further comprises a second metal plate perpendicular with the first metal plate, the first end of the heat transmission part abuts against the second metal plate, the heat transmission part is made from metal.
